(19) United States
(12) Patent Application Publication
(10) Pub. No.: US 2002/0124164 A1
(43) Pub. Date: Sep. 5, 2002

(54) Method for starting computer system

(75) Inventors: Masahiro Kiyoi, Kawasaki (JP); Hirofumi Nagasuka, Sagamihara (JP); Masaya Ichikawa, Sagamihara (JP); Akira Otsuji, Yokohama (JP)

Correspondence Address: McDermott, Will & Emery, 600 13th Street, N.W., Washington, DC, 20005-3096, US

(73) Assignee: Hitachi, Ltd.

(21) Appl. No.: 10/067,781

(22) Filed: Feb. 8, 2002

(30) Foreign Application Priority Data
Mar. 2, 2001 (JP) 2001-057650

(51) Int. Cl. G06F 15/177; G06F 9/00; G06F 9/24

(52) U.S. Cl. 713/1

(57) ABSTRACT

In this invention, a main storage is divided into an area that should be initialized and an area that should not be initialized at the time when the system is restarted. Part of the main storage area that should not be initialized is allocated to a table for managing a use situation of the main storage and a use situation of an address space. After the restart, for a request for main storage allocation to the virtual space whose contents should be taken over, part of the main storage area that should not be initialized is allocated to a virtual space and part of the main storage area that should not be initialized is also allocated to an address translation table corresponding to the virtual space. For a request for main storage allocation to the virtual space other than the above-mentioned request, part of the main storage area that should be initialized is allocated thereto. At the time of the restart, only areas that should be initialized are subjected to the initialization. Also for a management table for a use state of the main storage, only parts thereof that correspond to the areas that should be initialized are subjected to the initialization.

### BACKGROUND OF THE INVENTION

The present invention relates to a method for utilizing main storage when a computer system is restarted.

When the computer system accepts a request to start the system from a user, first the computer system reads a system initialization program for executing initialization from an external storage into its main storage.

The system initialization program causes the process to initialize the whole of the main storage (filling with zeros) and then read a program necessary for subsequent operations. Not only when the system is started for the first time but also similarly when there occurs a necessity to restart the computer system for a reason of outbreak of a failure etc., the system initialization program causes the process to execute the initialization of the main storage.

On the other hand, as one of purposes of utilizing the main storage of the computer system, there is a use of cache for accelerating access to a file in the external storage. The use of cache means a use mode of the main storage where a certain size of a buffer area is reserved in the main storage, in which some pieces of data that have higher frequencies of access among pieces of data in the file are placed. When a request arises that refers to a piece of file data; if the said data exists in the buffer area, the process does not access to the main body of the file but reads the data from the buffer area in the main storage. By decreasing input/output operations for file access, the file access can be made accelerated. A cache control program continues to monitor the file access to check sequentially which piece of data has a higher frequency of access. In response to the result, the pieces of data each having a higher frequency of access are placed in the buffer area, and thereby the effective utilization of the main storage is realized.

In the above-mentioned conventional technology, as the capacity of the main storage increases, the length of time to restart the computer system due to the occurrence of a failure becomes longer. In particular, it is necessary to mitigate the elongation of the restart time due to increase in the capacity of the main storage when a representation of real storage address is extended, for example, from 8 bits to 16 bits, 16 bits to 32 bits, 32 bits to 64 bits, etc.

Besides, when the capacity of the main storage increases, the length of time to construct data that will be used by each program on the main storage also becomes longer. Also in the case of the cache control program described in the conventional technology, since the restart of the computer system initializes the buffer that had been constructed by continuously monitoring the file access just before the restart, the buffer area in which pieces of data having higher frequencies of access are placed cannot be reconstructed unless the access to the files in the external storage are monitored again for a certain time.

### SUMMARY OF THE INVENTION

It is the object of the present invention to shorten the restart time at the time when the computer system is restarted due to the occurrence of a failure etc. Further, it is another object of the present invention to provide an environment where a program that places a large amount of data in the main storage can reuse the data on the main storage that was used by the program before the restart.

To accomplish the above-mentioned objects, in a computer system that has a main storage and an auxiliary storage and adopts virtual memory management that designates in which area in the said main storage or the said auxiliary storage individual areas of virtual memory are placed, a method for starting a computer system according to the present invention divides the main storage into a first main storage area that should be initialized and a second main storage area that should not be initialized at the time when the system is started. Further, the individual areas of the virtual memory are divided into a first virtual area that utilizes the said first main storage area and a second virtual area that utilizes the said second main storage area. Moreover, for a request from the program to allocate blocks of memory in the main storage to the said first virtual area (hereinafter referred to as “a request for main storage allocation to the said first virtual area”), the process allocates an area belonging to the first main storage area, and for a request for main storage allocation to the said second virtual area, the process allocates an area belonging to the second main storage area. Furthermore, at the time when the system is started, the contents of the first main storage area are initialized whereas the contents of the second main storage area are retained.

In addition, in the method for starting a computer system according to the present invention, when the main storage is divided into the two areas as described above, either of an area whose memory addresses are lower than a previously specified address on the main storage and an area whose memory addresses are not lower than the said address is designated to the first main storage area and the rest is designated to the second main storage area.

In addition, the method for starting a computer system according to the present invention dynamically allocates part of the main storage to each of the individual areas in the virtual memory according to an attribute borne by each individual area in the virtual memory when the individual areas in the virtual memory are divided into the two areas in the manner described above.

### BRIEF DESCRIPTION OF THE DRAWINGS

FIG. 1 is a configuration diagram of a computer system that shows an embodiment according to the present invention;

FIG. 2 is a structural drawing of a main storage management table;

FIG. 3 is a structural drawing of the space (address space) management table;

FIG. 4 is a view illustrating a relationship between the virtual memory and the main storage;

FIG. 5 is a structural drawing of an address translation table;

FIG. 6 is a flowchart of a device of initializing main storage;

FIG. 7 is a flowchart of a device of allocating main storage;

FIG. 8 is a flowchart of a device of reconstructing space;

FIG. 9 is a view illustrating resetting of a space management table;

FIG. 10 is a view illustrating a change in a use state of the main storage;

FIG. 11 is a view illustrating how either of the basic area or the extended area in the main storage is allocated to a virtual memory area according to its space attribute;

FIG. 12 is a view illustrating an example of application to the cache control program;

FIG. 13 is a configuration diagram showing a second embodiment;

FIG. 14 is a structural drawing of the main storage management table in the second embodiment;

FIG. 15 is a flowchart of a device of determinating type of area;

FIG. 16 is a flowchart of a device of reconstructing area; and

FIG. 17 is a structural drawing of the address translation table in a third embodiment.

### DESCRIPTION OF THE PREFERRED EMBODIMENTS

Hereafter, the embodiments according to the present invention will be explained in detail with reference to the drawings.

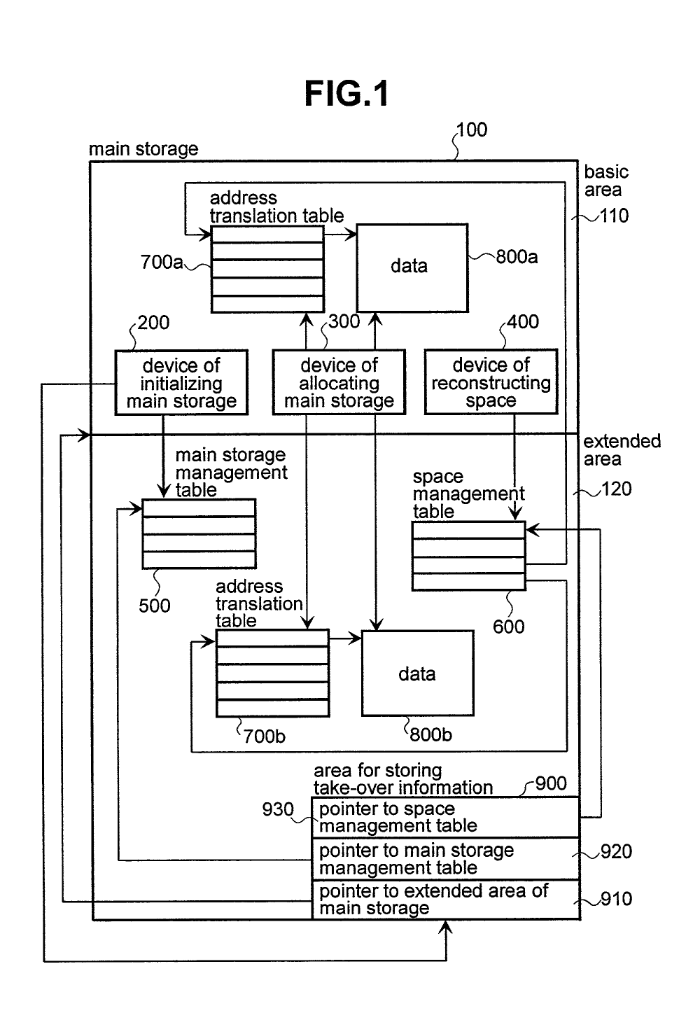

First, referring to FIG. 1 through FIG. 12, the first embodiment will be described.

FIG. 1 shows the configuration of the main storage of the computer system according to this embodiment. A main storage 100 is composed of a basic area 110 whose memory addresses are lower than a certain address being set for a boundary and an extended area 120 whose memory addresses are not lower than that address.

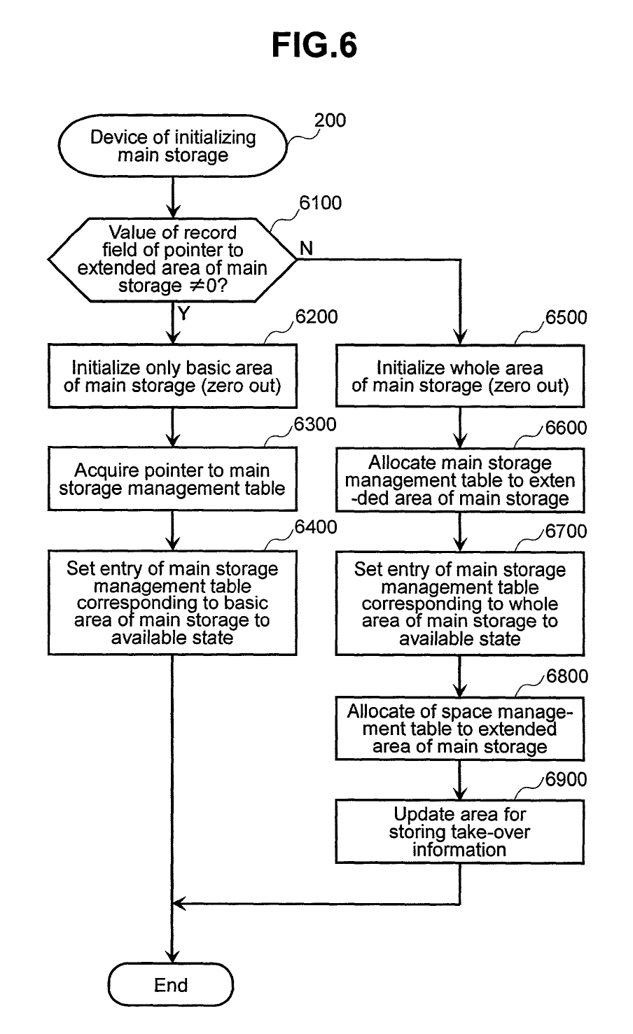

At the time when the computer system is started, the device of initializing main storage 200 initializes a main storage management table 500 for storing use situation management information of the main storage to make the main storage reusable. The device of allocating main storage 300 accepts a request for main storage allocation from each program that is running in the computer system, selects an area that is not utilized by other programs from the main storage, and allocates it to the program that requires it. A device of reconstructing spaces 400, being executed at the time when the computer system is restarted, selects spaces such that information of each space has been retained in the extended area 120 of the main storage from among spaces that were utilized before the restart and sets them in an available state. Concrete processing contents of these processing devices will be described referring to FIG. 6 through FIG. 8, respectively.

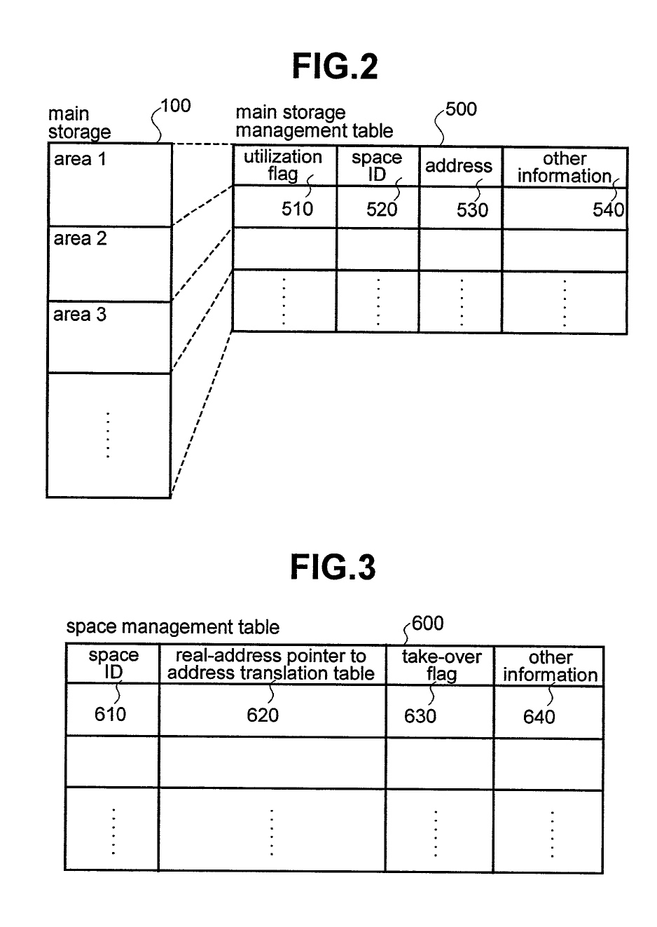

The main storage management table 500 records the use situation of each area of the main storage 100. A space management table 600 stores information necessary to utilize each space that has been created in the computer system. The above-mentioned tables 500, 600 and two address translation tables 700a, 700b that were provided in the basic area 110 and the extended area 120, respectively, will be described referring to FIG. 2 through FIG. 5, respectively.

Data areas 800a, 800b are the data areas that were allocated to the spaces created in the computer system.

An area for storing take-over data 900 is the area for storing information necessary to make the space, to which part of the extended area 120 of the main storage was allocated, usable after the restart of the computer system. The said area for storing take-over data 900 was provided beforehand at a certain address of the main storage 100 and it is assumed that each processing device can have the knowledge of the address.

The area for storing take-over data 900 is composed of a pointer to extended area of main storage 910, a pointer to main storage management table 920, and a pointer to space management table 930. The pointer to extended area of main storage 910 designates a field for storing a boundary address that divides the main storage 100 into the basic area 110 and the extended area 120. The pointer to main storage management table 920 designates a field for storing a head address at which the main storage management table 500 was placed. The pointer to space management table 930 designates a field for storing a head address at which the space management table 600 was placed.

Next, referring to FIG. 2, the structure of the main storage management table 500 will be described. The main storage management table 500 is the table for controlling the use situation of the main storage 100. The main storage 100 is logically divided into areas of a smaller size and a plurality of entries each corresponding to one of the areas are provided in the main storage management table 500. Among fields in each entry, a field of a utilization flag 510 stores a flag indicating whether the area corresponding to entry is utilized by any of the spaces or not. If the area is being utilized, the flag is set to ON; if it is not being utilized by any space, the flag is set to OFF. When the area corresponding to entry is utilized by any of the spaces, a field of a space ID 520 stores an identifier of a space. When the area corresponding to entry is utilized by any of the spaces, a field of an address 530 stores a virtual address in the space that the said area was allocated to. A field of other information 540 is provided as the field that stores information required to control each area of the main storage 100 if there exists such information except the above pieces of information, but is not used in this embodiment.

As shown in FIG. 1, the main storage 100 is divided into the basic area 110 and the extended area 120. Accordingly, the main storage management table 500 is divided into a group of entries that corresponds to the basic area 110 and a group of entries that corresponds to the extended area 120. Note that the table configurations of the two groups may be the same.

FIG. 3 is the configuration diagram of the space management table 600. The space management table 600 is the table for storing information required to control a space that is under execution in the computer system, where each entry in the table corresponds to one space, respectively. In this embodiment, it is assumed that the space management table 600 is configured such that a certain number (for example, an upper-limit number of spaces that the computer system can operate simultaneously) of entries are arranged serially in the main storage. Note that it is not always necessary for arrangement of the entries to be serial: a configuration where the entries are linked to its previous and subsequent entries with pointers designating their storage locations may be used.

A field of a space ID 610 in each entry of the space management table 600 stores the identifier of a space that is managed by the said entry. If a space to be managed is not registered in the entry, it stores a special identifier, such as “NULL” and “0.” A field of a real-address pointer to address translation table 620 stores an address on the main storage 100 at which the address translation table 700a/700b for the corresponding space is placed. A take-over flag 630 is the flag indicating whether or not the computer system is going to utilize the corresponding space even after the restart. If the space should be utilized after the restart, the flag is set to ON, and if not be utilized, the flag is set to OFF. A field of other information 640 is provided as the field that stores information required to control each area if there exists such information except the above pieces of information, but is not used in this embodiment.

Each field of the space management table 600 is set up when the space is created. Here, in this embodiment, the spaces are sorted into the space that should be utilized after the restart and the space that is not so by using the existing space attribute. For example, JP-A-225065/1993 discloses a computer system wherein there exists a data space where only data can be placed besides a normal address space where either of a program or data can be placed. In the case where the exsiting space attribute like this is used, the take-over flags 630 of the space management table 600 for the data spaces are set to ON whereas the take-over flags 630 for other address spaces than the data spaces are set to OFF.

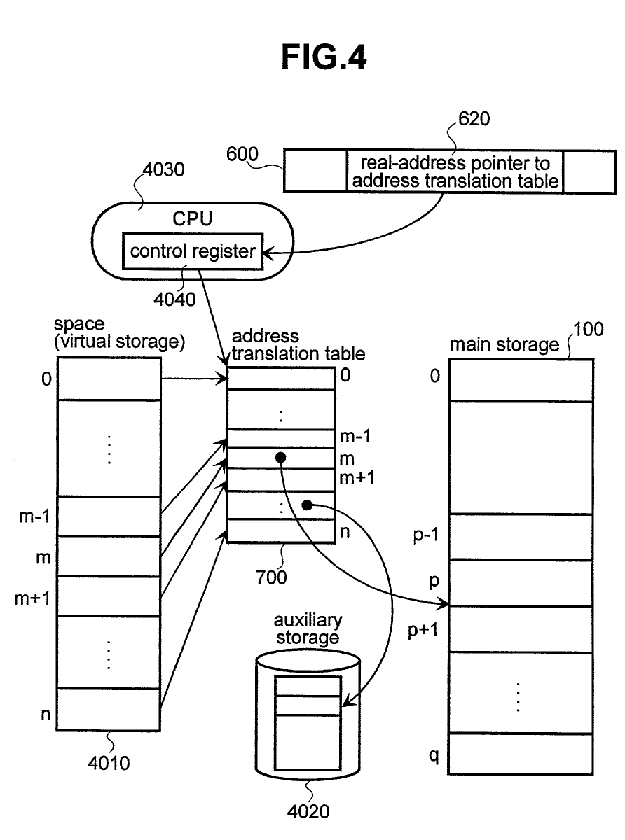

Referring to FIG. 4, how to obtain the real address from the virtual address and the relationship between the space (virtual memory) and the main storage will be described. In FIG. 4, the space (virtual memory) 4010 is separated in units of a certain-length size. Each of these separated units is named a page. The virtual memory 4010 in this embodiment is composed of (n+1) pages. Then, the head page is named “0 page” and the last page is named “n page.”

The areas of the virtual memory 4010 are actually mapped onto the main storage 100 or on the auxiliary storage 4020 on a page-by-page basis. It is the address translation tables 700a, 700b that serve to grasp in which area of the main storage 100 or the auxiliary storage 4020 each page of the virtual memory 4010 is placed. The address translation tables 700a, 700b per se are actually placed in continues areas on the main storage 100 as shown in FIG. 1. Further, the address translation tables 700a, 700b are provided with entries each corresponding to each page of the virtual memory 4010. That is, the address translation tables 700a, 700b each are composed of (n+1) entries. Then, the sequence of the pages of the virtual memory 4010 is made to correspond to the sequence of the entries of the address translation table 700a(700b). For example, the entry of the address translation table 700a(700b) that corresponds to the m-th page of the virtual memory 4010 is the m-th entry. A real address of the head of the address translation table is stored in a control register 4040 in a CPU 4030. For the real address that is stored in the control register 4040, a value of the real-address pointer to address translation table 620 in the space management table 600 that has been provided so as to correspond to the virtual memory, namely the space 4010, is copied.

The main storage 100 is also separated in units of a certain-length size. This separated unit is also named a page in the same manner as the unit of the above-mentioned virtual memory 4010, and its size is identical to that of the page of the virtual memory 4010. The main storage 300 of this embodiment is composed of (q+1) pages, and the head page is named “0 page” and the final page is named “q page.”

In this way, by conforming the page sizes of the virtual memory 4010 and of the main storage 100 to each other, correspondences between the pages of the virtual memory 4010 and those of the main storage 100 can be established with the help of the address translation tables 700a, 700b. FIG. 4 shows that the m-th page of the virtual memory 4010 is mapped onto the (p+1)th page of the main storage 100.

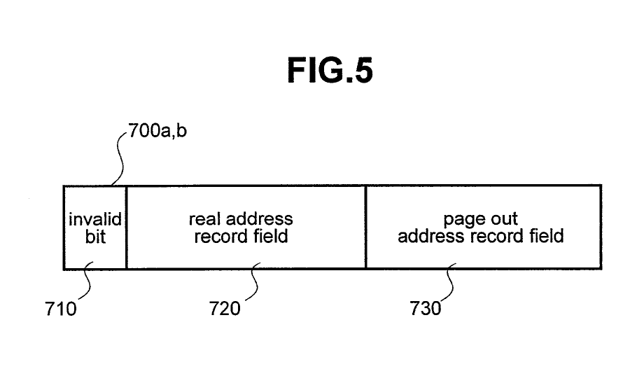

Next, the contents of the entries of the address translation table 700a(700b) will be described. FIG. 5 is the configuration diagram of the entries of the address translation table 700a(700b). An address translation table entry is composed of at least an invalid bit 710, a real address record field 720, and a page out address record field 730.

The real address record field 720 stores a page number on the main storage 100 at which the page on the virtual memory 4010 corresponding to the said entry is placed. It is the invalid bit 710 that indicates whether the content of the real address record field 720 is valid not.

When the invalid bit 710 is ON, it indicates that the content of the real address record field 720 is invalid. That is, the virtual page corresponding to the said entry is either not being utilized or paged out to the auxiliary storage 4020. When being paged out to the auxiliary storage 4020, its page out address is stored in the page out address record field 730.

On the other hand, when the invalid bit 710 is OFF, it indicates that the content of the real address record field 720 is valid. That is, it indicates that the page on the virtual memory 4010 corresponding to the said entry is placed on a page of the main storage 100 that is designated by the real address record field 720.

FIG. 6 is a process flowchart of the device of initializing main storage 200. The device of initializing main storage 200 is first read into the main storage at the time when the computer system is started, and initializes the main storage management table 500 so that other programs can utilize the main storage 100.

First, the process determines whether the value of the take-over data is “0” or not by referring to the pointer to extended area of main storage 910 of the area for storing take-over data 900 that is placed at a predetermined address of the main storage 100. If the value is not “0,” it is assumed that taking over the data in the extended area 120 of the main storage has been specified while the computer system was in operation before the restart thereof. In this case, following this, the contents of the basic area 110 of the main storage are initialized (step 6200). The boundary address between the basic area 110 and the extended area 120 has already been acquired at the previous step. Subsequently, the address at which the main storage management table 500 was placed is acquired by referring to the pointer to main storage management table 920 (step 6300).

The process sets only part of the entries of the main storage management table 500 that correspond to the basic area 110 of the main storage in the available state using the address 920 (step 6400). Setting the main storage management table 500 in the available state means that the utilization flags 510 are set to OFF and the contents of the space IDs 520 and addresses 530 are deleted.

In the foregoing processing, the extended area 120 of the main storage is off the subject of the initialization, and part of the entries of the main storage management table 500 that correspond to the extended area 120 are held as it was before the restart.

In the determination at the step 6100, if the value of the pointer to extended area of main storage 910 is “0,” it indicates that either this operation is not the restart but the first start-up after the computer system has been turned on or this operation is the restart such that taking over the contests of the extended area 120 has not been specified before the restart. In this case, the extended area 120 should also be the subject of the initialization. That is, the whole area of the main storage 100 is initialized. (step 6500) Note that areas necessary for the operation of the computer system, such as an area into which the device of initializing main storage 200 per se was read, are not subjected to the initialization, as exceptions. Next, part of the extended area 120 is allocated to the main storage management table 500 (step 6600). The main storage management table 500 that the extended area 120 has been allocated to including its part corresponding to the extended area 120 is initialized to the available state (step 6700).

Subsequently, another part of the extended area 120 is allocated to the space management table 600 (step 6800). However, for the said space management table 600, the allocation of the extended area 120 thereto can be done each time the individual space is created rather than in the middle of initializing the system as shown in this embodiment.

After that, the area for storing take-over data 900 is updated (step 6900). Concretely, the boundary address between the basic area 110 and the extended area 120 on the main storage 100 gets stored at the address of the pointer to extended area of main storage 910. In this embodiment, it is assumed that the device of initializing main storage 200 is provided with this boundary address information beforehand. Further, the address of the main storage management table 500 that part of the extended area 120 has been allocated to by the step 6600 gets stored at the address of the pointer to main storage management table 920, and the address of the space management table 600 that part of the extended area 120 has been allocated to by the step 6800 gets stored at the address of the pointer to space management table 930.

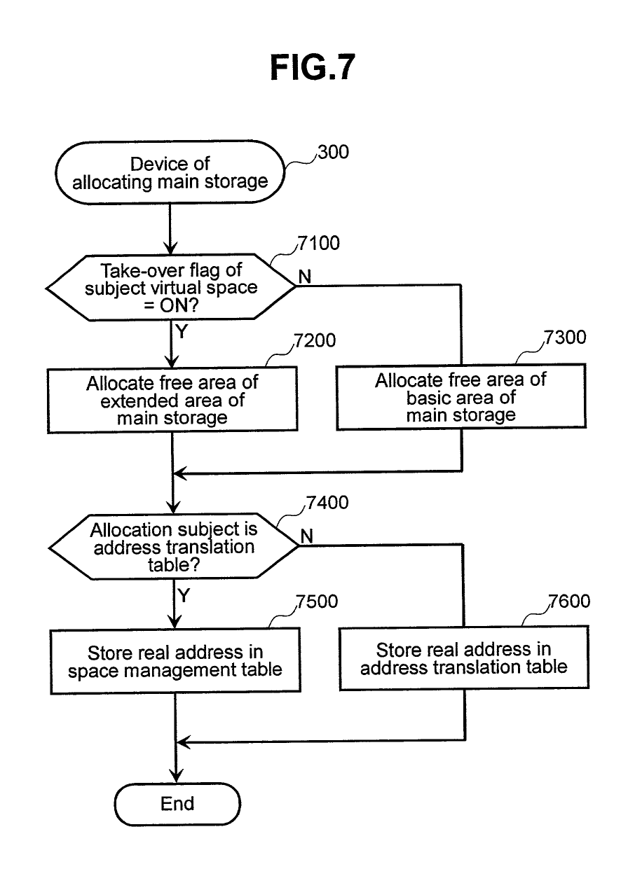

FIG. 7 is the process flowchart of the device of allocating main storage 300. The device of allocating main storage 300 accepts a request for main storage allocation from a program that utilizes the spaces, and allocates part of the main storage area to the spaces according to their attributes. First, the space management table 600 for the space that is a source of request for main storage allocation is referred to, and whether the contents of the take-over flag 630 is ON or OFF is determined (step 7100). Information is set on this flag according to the space attribute when the space is created. If the flag 630 is ON, it indicates that a corresponding space is the space that should be reused again after the restart of the computer system. At this time, a free area is found out from the extended area 120 of the main storage and is allocated to the space that is a source of request (step 7200). If the above-mentioned flag 630 is OFF, the space is the space that should not be reused after the restart, and so an empty area is found out from the basic area 110 of the main storage and is allocated to the space that is a source of request. (Step 7300)

Subsequently, it is determined whether the area required to be allocated is the address translation tables 700a, 700b or the data areas 800a, 800b other than the former (step 7400). This determination can be realized by specifying beforehand that the address translation tables 700a, 700b should be placed in a specific range on the virtual memory. If the allocation is for the address translation tables 700a, 700b, an address of the allocated area is stored at the real-address pointer to address translation table 600 of the corresponding space management table 600 (step 7500). If the allocation is for the data areas 800a, 800b, an address of the allocated area is stored in the real address record field 720 in the address translation tables 700a, 700b that manages the said data areas 800a, 800b (step 7600). Note that whether the area required to be allocated is the address translation table 700a or the table 700b is decided by the determination result at the above-mentioned step 7100. Note also that whether the area required to be allocated is the data area 800a or the data area 800b is decided similarly.

Through the foregoing processing, the address translation tables 700a, 700b and the data areas 800a, 800b of the space can be placed in either the basic area 110 or the extended area 120 of the main storage according to the space attribute, effecting their separation.

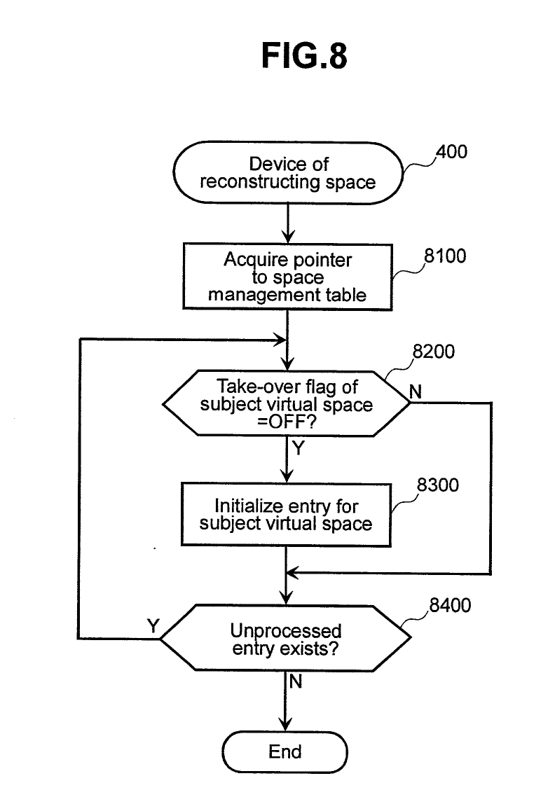

FIG. 8 is the process flowchart of the device of reconstructing spaces 400. The device of reconstructing spaces 400 is executed, after the computer system was restarted, to reset the space management table 600. The execution of the device of reconstructing spaces 400 is done before the general user begins to use it, for example, just after the device of initializing main storage 200 was executed. First, the process refers to the area for storing take-over data 900 and acquires the pointer to space management table 930 (step 8100). Since part of the extended area 120 has been allocated to the space management table 600 by the device of initializing main storage 200 before the restart of the computer system, the contents have been retained even after the restart.

The process refers to the entries of the table 600 one by one and determines whether the take-over flag 630 is ON or OFF (step 8200). The space whose flag 630 is OFF cannot be reused because the corresponding address translation tables 700a, 700b and the data areas 800a, 800b have been initialized by the restart. Therefore, for any entry corresponding to such a space, the contents are initialized (step 8300). For the entry whose flag 630 is ON, the contents before the restart can be reused, because the contents as it were has been retained. Subsequently, the process determines whether the next entry exists or not (step 8400), and if it exists, the process move to the next entry and repeats the processing from the step 8200.

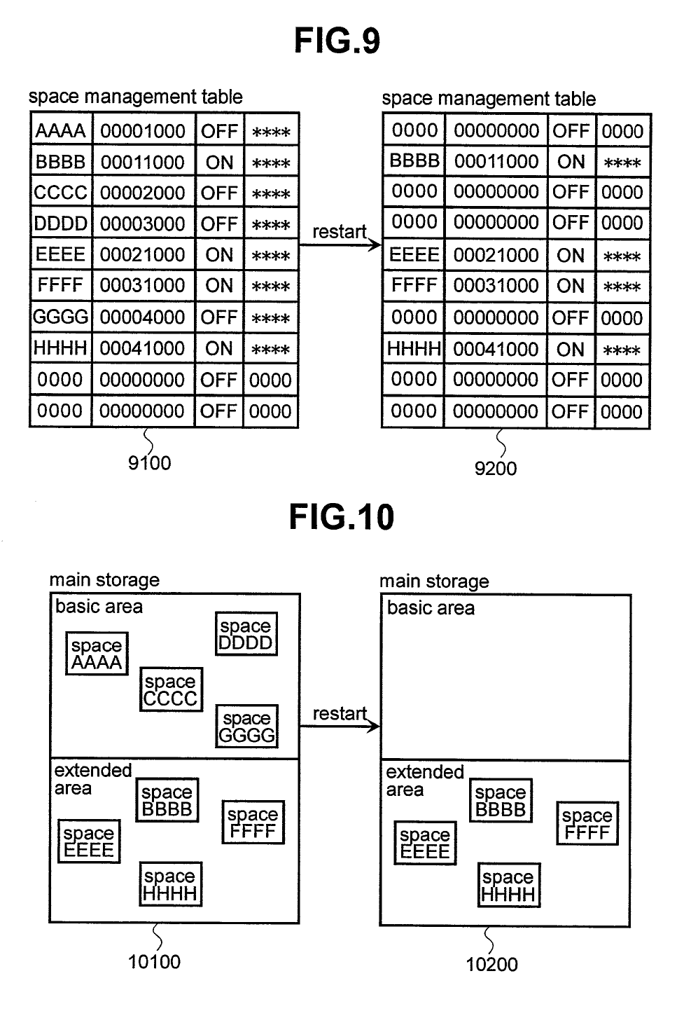

FIG. 9 shows an example where the contents of the space management table 600 were reset by the device of reconstructing spaces 400. In FIG. 9, a table 9100 shows a state of the space management table 600 before the resetting, namely before the computer system is restarted, and the table 9200 shows a state after the space management table 600 was reset by the device of reconstructing spaces 400. In the space management table 9100, any space whose take-over flag 630 is OFF is the space that utilized the basic area 110 of the main storage.

In this way, the entries that correspond to spaces whose take-over flags 630 are OFF, namely four spaces whose space IDs 610 are AAAA, CCCC, DDDD, and GGGG are initialized. In this embodiment, “0” is assigned to the fields of the entry (except the take-over flag 630) as the initialization of the entry. For the entries that correspond to four spaces whose take-over flags 630 are ON, namely four spaces whose space IDs are BBBB, EEEE, FFFF, and HHHH, the contents are not updated.

FIG. 10 shows (situation 10100) a space use situation of the main storage 100 before the reset and (situation 10200) that after the reset, in the same state as that of FIG. 9.

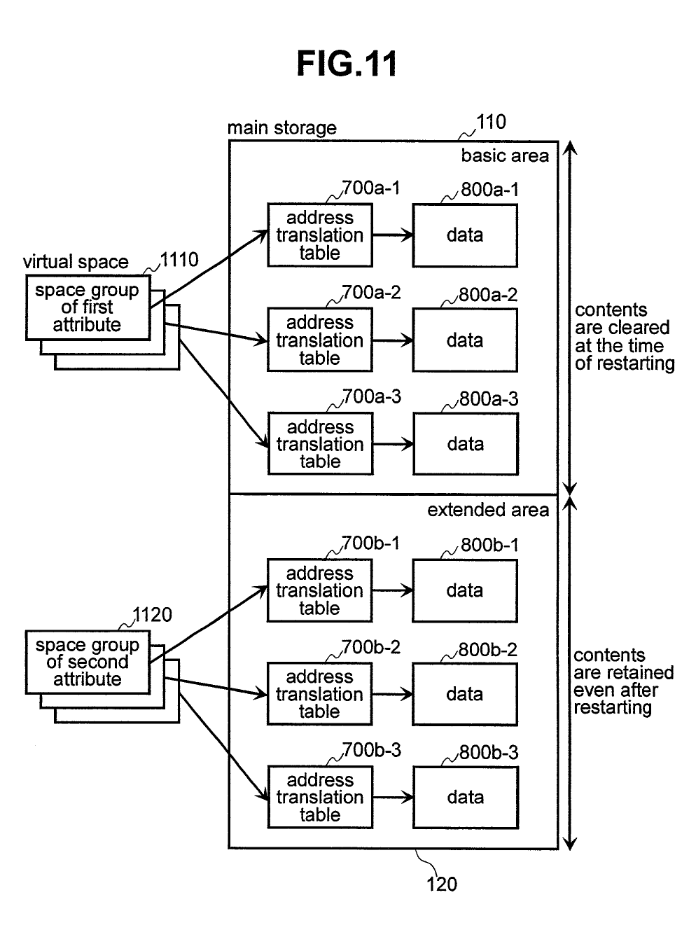

FIG. 11 shows a situation where the spaces are sorted into the following two categories of spaces according to the attribute that each space has been provided with beforehand: (1) space that utilizes the basic area 110 of the main storage; and (2) space that utilizes the extended area 120 and whose contents should be retained even after the restart. In FIG. 11, spaces 1110 are a group of spaces each having a first attribute prescribing that part of the basic area 120 should be allocated to the pertinent space. Spaces 1120 are a group of spaces each having a second attribute prescribing that part of the extended area 120 should be allocated to the pertinent space. Here, as one example of the space attribute that acts as a determining factor for deciding which area of the main storage should be allocated to the space, there is an attribute indicating whether or not the space is an only-data-placement space where no program can be placed.

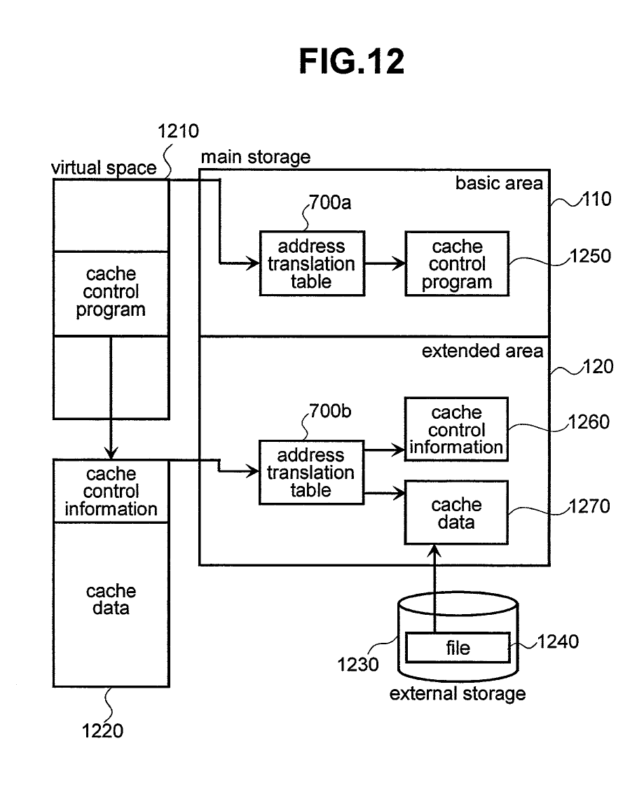

FIG. 12 is the view illustrating the use mode of the space more concretely in this embodiment. The virtual space (virtual address space) 1210 shown in FIG. 12 is the space where a program can also be placed, and a cache control program 1250 was placed therein in this embodiment. The cache control program 1250 is the program whereby a file access speed is enhanced by monitoring an access state to a file 1240 stored in the external storage 1230 and, according to the access state, retaining data having a higher frequency of access on the main storage.

The cache control program 1250 shown in FIG. 12 places, in an only-data-placement space 1220, cache control data 1260 that involves placement locations on the main storage for the data in the virtual space and the access state of that data and cache data 1270 in the virtual memory area that corresponds to the data actually placed on the main storage, and allows other programs to utilize it. By allocating the extended area 120 to the space with the attribute indicating that the space is for only-data-placement, the cache control data 1260 and the cache data 1270 are made available even after the restart of the computer system. That is, by virtue of this function, it is not necessary for the cache control program 1250 to monitor the state of file access and find out a frequency of access in order to create the cache data 1270. As a result, after the restart, an environment that speeds up the file access can be built up in a short time.

Next, the second embodiment will be described. In the first embodiment, the main storage 100 is divided into the basic area 110 and the extended area 120 according to the predetermined boundary address, whereas in the second embodiment, such division of the main storage is not executed. It is dynamically determined whether each of the main storage areas is subjected to the initialization or not at the time when the system is restarted depending on the attribute of the virtual memory area that a main storage area was allocated to. Therefore, in this second embodiment, it is not necessary to provide the pointer to extended area of main storage 910 in the main storage 100.

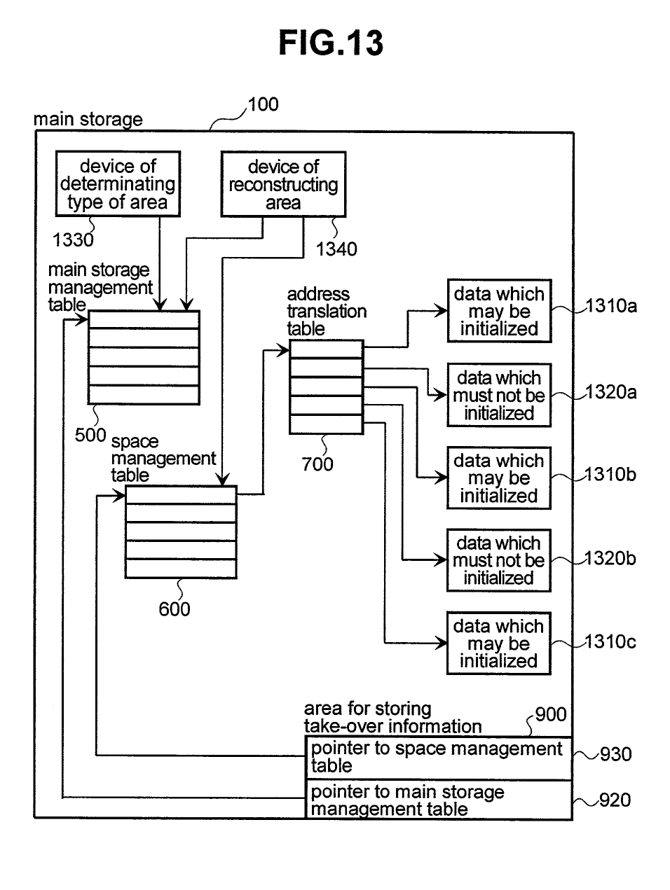

FIG. 13 is a figure of the principle for the second embodiment. The main storage 100, the main storage management table 500, the space management table 600, and the address translation table 700 shown in FIG. 13 are the same as those in the first embodiment. Here, each area of the main storage 100 that was actually allocated to the space is pointed to by each entry of the address translation table 700, and in FIG. 13 each area thus pointed to has the attribute of either data which may be initialized 1310a, b, c or data which must not be initialized 1320a, b. These attributes are dynamically given to the corresponding area of the virtual space as a result of setting specification indicating whether the contents should be initialized at the time of the restart or not. It is a device of determinating type of area 1330 that determines such attributes. Further, it is a device of reconstructing area 1340 that selects and initializes only areas that were specified to be the subject of the initialization at the time of the restart according to the attributes that have been given to the respective areas of the main storage 100.

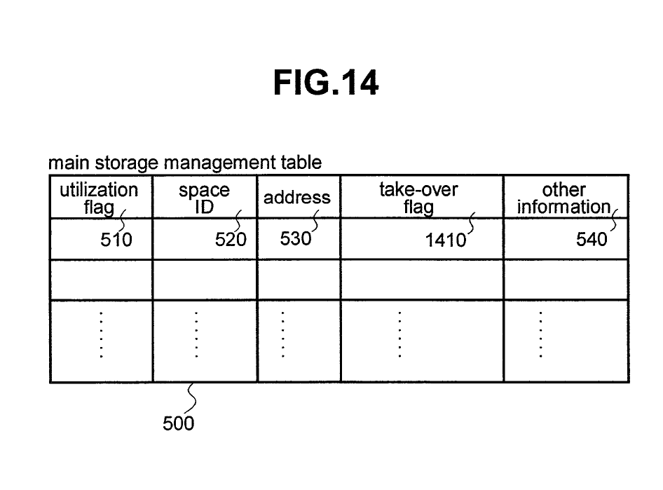

FIG. 14 shows the composition of the main storage management table 500 in the second embodiment. A difference from the first embodiment is a point that a take-over flag 1410 was added. The flag 1410 is the flag indicating whether the area of the main storage 100 managed by the said entry should be initialized at the time of the restart or not. If the flag 1410 is OFF, the initialization is going to be done, and if the flag is ON, the contents is going to be retained. The setting of the flag 1410 is done by the device of determinating type of area 1330.

In this embodiment there is provided means for allowing the user to define the attribute prescribing that the contents should be retained at the time when the system is restarted for a specific area involved in a specific virtual space. As means for giving such a definition, for example, a command in the format shown below is newly provided. MEMPROT SPACEID, (ADDR1, ADDR2)

In the above-mentioned command, “MEMPROT” is a name for a command that requires the device of determinating type of area 1330 to be started. “SPACEID” specifies a space identifier (attribute) of the virtual space that is to be processed. “ADDR1, ADDR2” specifies a range of addresses, in the specified space, whose contents should be retained at the time of the restart. Note that the range specified here is the one of the virtual addresses each designating an address in the virtual space.

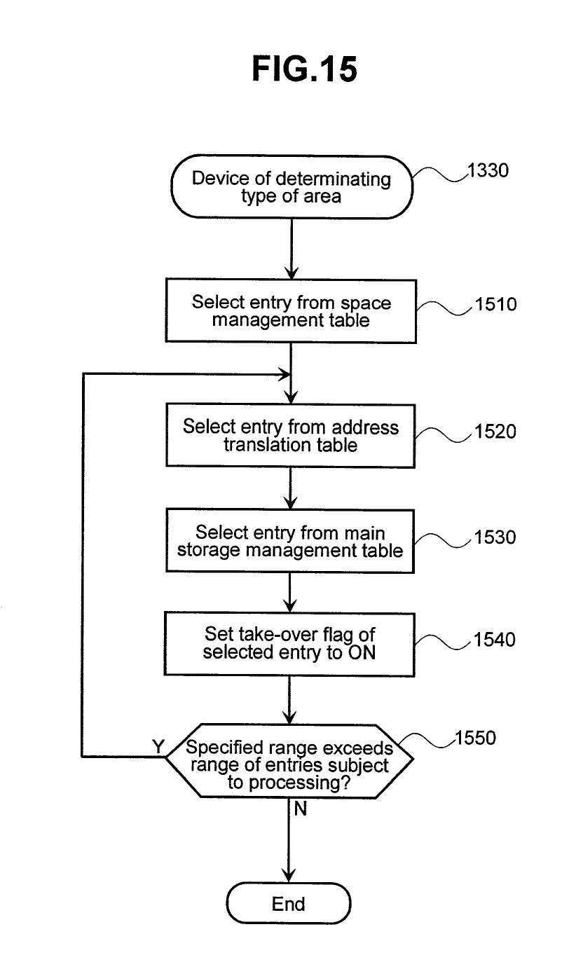

FIG. 15 is the process flowchart of the device of determinating type of area 1330. The device of determinating type of area 1330 is started when the above-mentioned MEMPOROT command was input. According to the specified SPACEID, an entry corresponding to the space to be processed is selected from within the space management table 600 (step 1510). According to the specified ADDR1 and ADDR2, an entry corresponding to address to be specified is selected from within the address translation table 700 that is pointed to by the space management table 600 (step 1520). An entry in the main storage management table 500 that corresponds to a real address stored in the address translation table 700 thus selected is selected (step 1530). ON is set to the take-over flag 1410 of the selected entry in the main storage management table 500 (step 1540).

If the specified range of addresses exceeds the range that is managed by a single entry of the address translation table 700, it is necessary to execute then the same processing for the adjacent entry successively. So, on the basis of the ADDR1 and ADDR2 specified by the user, it is determined whether or not the specified range exceeds the range of the entries of the address translation table 700 that was processed presently (step 1550). If the specified range exceeds that range, the process returns to the step 1520 and continues the processing.

By the above-mentioned processing, for the main storage area allocated to the virtual memory area whose attribute has been defined by the user as the one prescribing that the contents should be retained at the time of the restart, the take-over flag 1410 in the main storage management table 500 that manages it is set to ON and thereby the main storage area is recognized as off the initialization subject at the time of the restart.

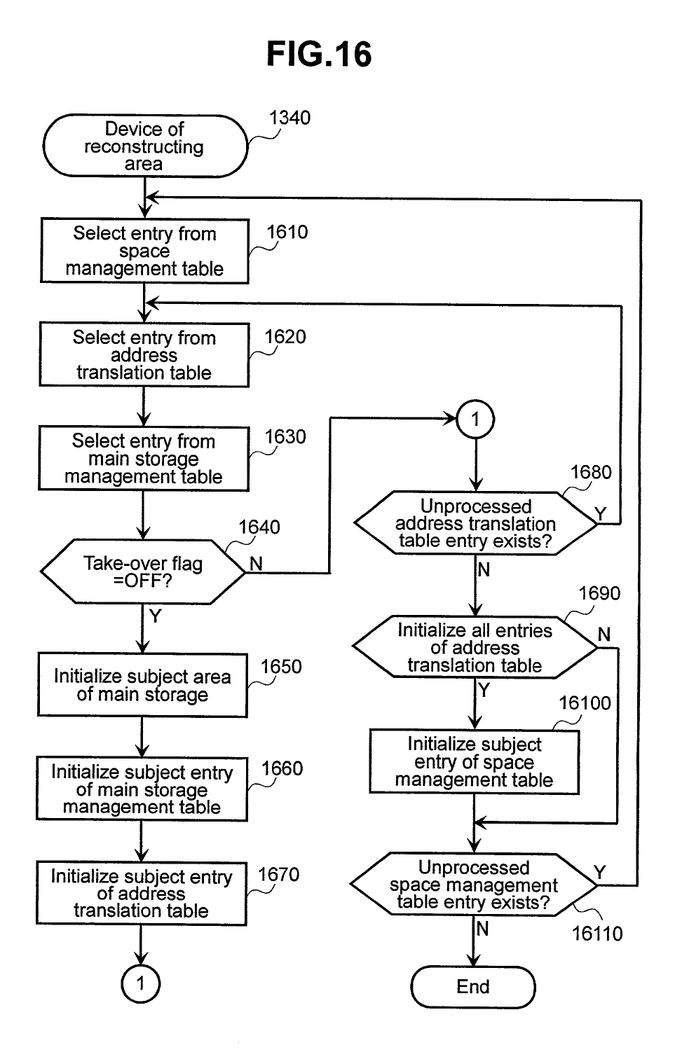

FIG. 16 is the process flowchart of the device of reconstructing area 1340. The device of reconstructing area 1340 either initializes the contents of some areas of the main storage or retains them according to the state that has been defined before the restart. Incidentally, the device of reconstructing area 1340 per se is loaded at a special location that does not come under the subject of the above-mentioned processing.

First, the process selects one entry from within the space management table 600 by referring to the pointer to space management table 930 that exists in a predetermined area of the main storage 100 (step 1610). From a real address that is pointed to by the selected entry, an entry in the address translation table 700 is selected (step 1620). From a real address stored in the selected entry of the address translation table 700, an entry in the main storage management table 500 that corresponds to the said real address is selected (step 1630). It is determined whether the take-over flag 1410 of the selected entry in the main storage management table 500 is OFF or not (step 1640). If the flag 1410 is OFF, the area of the main storage 100 that is managed by the entry in the main storage management table 500 is initialized (step 1650). Further, the contents of the entry itself in this main storage management table 500 are initialized (step 1660).

Moreover, the contents of the entry in the address translation table 700 that was selected at the step 1620 is initialized (step 1670).

Subsequently, it is determined whether an entry to be processed remains in the address translation table 700 or not (step 1680), and if an entry to be processed exists, this entry is considered as the subject of the processing and the process returns to the step 1620 to continue the processing.

When the processing has been completed for all the entries, it is determined whether all the entries in the address translation table 700 for the space to be processed have been initialized or not (step 1690). If all the entries have been initialized, the entry in the space management table 600 that was selected at the step 1610 is initialized (step 16100).

Subsequently, it is determined whether an entry to be processed remains in the space management table 600 or not (step 16110), and if an entry to be processed exists, the said entry is considered as the subject of the processing and the process returns to the step 1610 to continue the processing.

By the foregoing processing, for a space that involves at least one area whose attribute has been defined as the one prescribing the contents retainment, only the said area(s) is made reusable and other areas than this (those) are initialized. Moreover, for a space that involves only areas whose attribute each have not been defined as the one prescribing the contents retainment, the actual space information is deleted in the course of the restart of the system.

In the two embodiments mentioned above, the address translation table 700 was of a one-stage composition. However, even for a computer system whose address translation table is of a two- or more-stage composition, the same means can be applied.

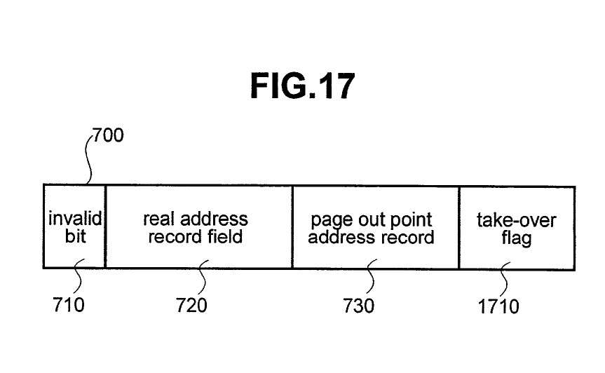

FIG. 17 is a configuration diagram of the address translation table in the third embodiment. In the third embodiment, some areas of the virtual space may be located on the auxiliary storage other than on the main storage. These areas are similarly sorted into the area whose contents should be retained at the time when the system is restarted and the area whose contents should be initialized at that time. To implement this, take-over flags 1710 are provided in the address translation table 700, as shown in FIG. 17. For any area whose attribute has been defined by the user as the one prescribing the reuse after the restart of the system, the take-over flag 1710 is set to ON. After the restart, the process checks the contents of each address translation table 700, and if the take-over flag 1710 is ON and the information was set in the page out address record field 730, the contents on the said auxiliary storage is retained. Further, if the take-over flag 1710 is OFF and the information was set in the page out address record field 730, the area of the said auxiliary storage is released and the contents of the area on the said auxiliary storage are initialized. If an area corresponding to the virtual memory area exists on the main storage, the processing is executed in the same manner as in the embodiments so far described.

According to the present invention, when the computer system is restarted due to the occurrence of a failure etc., the length of time to execute the initialization at the time of the restart is shortened by specifying specific areas of the main storage to be excluded from the subject of the initialization.

In addition, the length of time to reconstruct the virtual memory in association with the restart is shortened by retaining the contents of the virtual memory that were utilized before the restart and making them available even after the restart by the same procedure.

What is claimed is:

1. A method for starting a computer system that adopts virtual memory management whereby in which areas of a main storage individual areas of virtual memory are placed is specified by using an address translation table, comprising the following steps:
a) dividing the main storage into a first main storage area that should be initialized and a second main storage area that should not be initialized at the time when the system is started;
b) dividing the individual areas of the virtual memory into a first virtual area that utilizes said first main storage area and a second virtual area that utilizes said second main storage area;
c) allocating an area belonging to the first main storage area to said first virtual area in response to a request for main storage allocation thereto;
d) allocating an area belonging to the second main storage area to said second virtual area in response to a request for main storage allocation thereto; and
e) initializing the contents of the first main storage area and retaining the contents of the second main storage area at the time when the system is started.

2. A method for starting a computer system according to claim 1, wherein said step a) is the step of designating either of a part of the main storage area whose memory addresses are lower than a previously specified address or a part of the main storage area whose memory addresses are not lower than that address as the first main storage area and also designating the rest of the two parts as the second main storage area.

3. A method f or starting a computer system according to claim 1, wherein said step b) is the step of dynamically allocating part of the main storage to each of the individual areas of the virtual memory depending on an attribute borne by each individual area of the virtual memory.

4. A method for starting a computer system, comprising the steps of:
a) dividing a main storage into a first main storage area that should be initialized and a second main storage area that should not be initialized at the time when the system is started; and
b) initializing the contents of said first main storage area and retaining the contents of said second main storage area at the time when the system is started.

5. A method for starting a computer system, comprising the steps of:
a) giving to each of individual memory areas of the main storage an identifier indicating whether said memory area should be initialized at the time when the system is started or not according to an attribute of said memory area; and
b) deleting the contents of the memory area that has the identifier prescribing indicating initialization and retaining the contents of the memory area that has the identifier indicating non-initialization.

6. A method for starting a computer system that has a main storage and an auxiliary storage and stores some areas of virtual memory in said auxiliary storage, comprising the steps of:
a) setting an identifier indicating whether or not the main storage should be initialized at the time when the system is started and a page out address in an address translation table; and
b) initializing the contents of an area that is designated by said address of said auxiliary storage at the time when the system is started if said identifier prescribing the initialization and information was set in said page out address.

7. A computer system, comprising:
a) means of dividing a main storage into a first main storage area that should be initialized and a second main storage area that should not be initialized at the time when the system is started; and
b) means of initializing the contents of said first main storage area and retaining the contents of said second main storage area at the time when the system is started.

8. A computer system having means of managing virtual memory that designating in which area of the main storage each of individual areas of the virtual memory is placed by using an address translation table, comprising:
a) means of dividing a main storage into a first main storage area that should be initialized and a second main storage area that should not be initialized at the time when the system is started;
b) means of diving the individual areas of the virtual memory into a first virtual area that utilizes said first main storage area and a second virtual area that utilizes said second main storage area;
c) means of allocating an area belonging to the first main storage area to said first virtual area in response to a request for main storage allocation thereto;
d) means of allocating an area belonging to the second main storage area to said second virtual area in response to a request for main storage allocation thereto; and
e) means of initializing the contents of the first main storage area and retaining the contents of the second main storage area at the time when the system is started.
